(19) United States
(12) Patent Application Publication
(10) Pub. No.: US 2018/0238742 A1
(43) Pub. Date: Aug. 23, 2018

(54) TIME AND TEMPERATURE TRACKER

(71) Applicants: BAXTER INTERNATIONAL INC., Deerfield, IL (US); BAXTER HEALTHCARE SA, Glattpark (Opfikon) (CH)

(72) Inventors: Kriti Basu, Libertyville, IL (US); Rajeev Madhukar Sahasrabudhe, Buffalo Grove, IL (US)

(21) Appl. No.: 15/895,665

(22) Filed: Feb. 13, 2018

Related U.S. Application Data
(60) Provisional application No. 62/460,463, filed on Feb. 17, 2017.

(51) Int. Cl. G01K 3/04; G06F 3/14; G01K 1/02

(52) U.S. Cl. CPC G01K 3/04; G01K 1/028; G06F 3/14

(57) ABSTRACT

A detection device for time and temperature tracking includes a signal processing unit in operable communication with a memory, a temperature sensor, a timer, and a display window. The detection device displays, via the display window, a first label.. The detection device detects, by the temperature sensor, a first temperature. The detection device determines, by the signal processing unit, a first temperature excursion, where the first temperature exceeds a first threshold. Responsive to determining the first temperature excursion, the detection device starts the timer configured to expire after a first duration of time. The detection device detects, by the temperature sensor, a second temperature. Responsive to either (1) the timer expiring after the first duration of time; or (2) determining, by the signal processing unit, a second temperature excursion, where the second temperature exceeds a second threshold, the detection device displays, via the display window, a second label.

### PRIORITY CLAIM

This application claims priority to U.S. Provisional Application No. 62/460,463, entitled “TIME AND TEMPERATURE TRACKER”, filed Feb. 17, 2017, the entire contents of which are incorporated herein by reference and relied upon.

### BACKGROUND

Certain medical products, such as Baxter Healthcare's TISSEEL fibrin sealant, and related packaging have particular storage requirements that are crucial to the product's overall efficacy. For example, certain medical products may need to be stored in a frozen state, thus requiring a warming period prior to use. Likewise, for example, certain medical products may have a room temperature stability related shelf life. In a related example, a particular shelf life expiration time may differ, depending on the physical state of the medical product (e.g., frozen vs. liquid). Thus, both time and temperature are important metrics to be monitored and controlled for certain medical products to safeguard their appropriateness for their intended use.

Typical procedures often require that personnel, such as doctors, nurses, and other medical personnel, manually measure time and temperature values, and subsequently record these values to ensure compliance with particular storage and product handling requirements. Unfortunately, manual measurement may be ineffective, as it is dis-continuous. For example, storage requirements may mandate that a product cannot exceed a certain threshold limit (e.g., 37 degrees Celsius). If the medical product exceeds this threshold limit for any duration of time, the product may no longer he usable. It should be appreciated that manual measurement may inadvertently miss these types of situations (e.g., a temporary temperature excursion) and is therefore both costly and potentially inaccurate. From a labor perspective, manual measurement takes up hospital personnel time and with shift changes, different employees, and chaotic hospital settings, manual measurement can lead to inaccuracies in measurement, wasted product, and other needless inefficiencies.

Accordingly, an improved method and system for managing storage temperature conditions and for displaying packaging storage history parameters and conditions is needed.

### SUMMARY

In an embodiment an improved method and system for displaying packaging storage history parameters and conditions is provided. In an example embodiment, a detection device includes a signal processing unit in communication with a memory, a temperature sensor, a tinier, and a display window. The detection device may display, via the display window, a first label. The detection device may detect, by the temperature sensor, a first temperature. The detection device may then determine, by the signal processing unit, a first temperature excursion, which is an instance where the first temperature exceeds a first threshold, such as defined by the Instruction for Use or Summary of Product Characteristics. Responsive to determining the first temperature excursion, the detection device may start the timer configured to expire after the passing of a first duration of time. The detection device may also detect a second temperature, via the temperature sensor. Responsive to either: (1) the timer expiring after the first duration of time, or (2) determining a second temperature excursion, the detection device may display, via the display window, a second label in an example embodiment, the second temperature excursion is an instance where the second temperature exceeds a second threshold.

In an embodiment, the detection device may be further configured to, responsive to displaying the second label, restart the timer configured to expire after the passing of a second duration of time. The detection device may also detect a third temperature via the temperature sensor. Responsive to either: (1) the timer expiring after the second duration of time, or (2) determining a third temperature excursion, the detection device may display, via the display window, a third label. In an example embodiment, the third temperature excursion is an instance where the third temperature exceeds a third threshold.

In another embodiment, the detection device may be further configured to use the temperature sensor to detect a fourth temperature and determine a fourth temperature excursion. The fourth temperature excursion is an instance where the fourth temperature exceeds a fourth threshold. The detection device may display, via the display window, a fourth label.

In various alternative embodiments, the fourth label is permanent such that, once the display window displays the fourth label, no other label may be subsequently displayed via the display window.

In an embodiment, each of the first label, the second label, the third label, and the fourth label has a symbol, indicia, or alpha-numeric text that may include one or more of: (i) Ready to Be Thawed, (ii) Ready to Be Warmed, (iii) Ready to Be Used, and (iv) Discard.

In various embodiments, the display window can display each of the first label and the second label on either individual displays or in a shared display.

In an embodiment, each of the first label and the second label are different colors.

In an embodiment, the detection device further comprises an activator allowing a user to manually start the timer via the activator. In various embodiments, the timer is configured to expire after the passing of the first duration of time.

In an embodiment, a user manually adjusts a value associated with at east one of the first threshold and the second threshold.

In another example embodiment, a packaging system includes a storage container and a detection device affixed to the storage container. The detection device may display a first label and detect a first temperature to determine a first temperature excursion, which is an instance where the first temperature exceeds a first threshold. Responsive to determining the first temperature excursion, the detection device may start a timer, configured to expire after the passing of a first duration of time. The detection device may also detect a second temperature. Responsive to either: (1) the timer expiring after the first duration of time, or (2) determining a second temperature excursion, the detection device may display a second label. The second temperature excursion is an instance where the second temperature exceeds a second threshold.

In an embodiment, the detection device may be further configured to, responsive to displaying the second label, restart the timer. The timer is configured to expire after the passing of a second duration of time. The detection device may detect a third temperature. Responsive to either: (1) the timer expiring after the second duration of time, or (2) determining a third temperature excursion, the detection device may display a third label. The third temperature excursion is an instance where the third temperature exceeds a third threshold.

In another embodiment, each of the first label, the second label, and the third label has a symbol, indicia, or alpha-numeric text that may include one or more of: (i) Ready to Be Thawed, (ii) Ready to Be Warmed, (iii) Ready to Be Used, and (iv) Discard.

In yet another embodiment, each of the first temperature and the second temperature are environmental storage temperatures of the storage container.

In another example embodiment, a method of displaying packaging storage history parameters and conditions includes displaying, via a display device, a first label. The method includes detecting, by a temperature sensor, a first temperature. The method further includes determining, by a signal processing unit, a first temperature excursion, which is an instance where the first temperature exceeds a first threshold. Responsive to determining the first temperature excursion, the method includes starting a timer. The timer is configured to expire after the passing of a first duration of time. The method includes detecting, by the temperature sensor, a second temperature. Responsive to either: (1) the timer expiring after the first duration of time, or (2) determining, by the signal processing unit, a second temperature excursion, the method includes displaying via the display device, a second label. The second temperature excursion is an instance where the second temperature exceeds a second threshold.

In an embodiment, the method further includes, responsive to displaying the second label, restarting the tinier. The timer is configured to expire after the passing of a second duration of time. The method includes detecting, by the temperature sensor, a third temperature. Responsive to either: (1) the timer expiring after the second duration of time, or (2) determining, by the signal processing unit, a third temperature excursion, the method includes displaying via the display device, a third label. The third temperature excursion is an instance where the third temperature exceeds a third threshold.

In another embodiment, the method further includes detecting, by the temperature sensor, a fourth temperature. The method includes determining, by the signal processing unit, a fourth temperature excursion. The fourth temperature excursion is an instance where the fourth temperature exceeds a fourth threshold. The method also includes displaying, via the display device, a fourth label.

In yet another embodiment, the fourth label is permanent such that, once the display device displays the fourth label, no other label may be subsequently displayed via the display device.

In an embodiment, a user manually starts the timer via an activator, and the timer is configured to expire after the passing of the first duration of time.

In an embodiment, a user manually adjusts a value associated with at least one of the first threshold and the second threshold.

It is accordingly an advantage of the present disclosure to improve time and temperature tracking, as packaging storage history parameters and conditions, for medical products.

It is another advantage of the present disclosure to increase healthcare worker efficiency by eliminating manual measurement of packaging storage history parameters and conditions.

It is a further advantage of the present disclosure to reduce costs associated with manual metric measurement.

It is yet a further advantage of the present disclosure to reduce wasted material associated with improper storage of medical products and related packaging.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE FIGURES

FIG. 1 is a schematic view of a detection device, according to an example embodiment of the present disclosure.

FIGS. 2A and 2B are side elevation views of the detection device, according to example embodiments of the present disclosure.

FIG. 3 is a flow chart of an example method for displaying packaging storage history parameters and conditions, according to an example embodiment of the present disclosure.

FIG. 4 is a flow chart of an example method for a typical user workflow for storage and preparation of a frozen product, according to an example embodiment of the present disclosure.

FIG. 5 is a flow chart of an example method for using the detection device, according to an example embodiment of the present disclosure.

FIG. 6 is a table of exemplary times and temperatures for various preparation stages associated with the detection device, according to an example embodiment of the present disclosure.

### DETAILED DESCRIPTION OF EXAMPLE EMBODIMENTS

As discussed above, an improved method and system for displaying packaging storage history parameters and conditions includes: improving time and temperature tracking of medical products, increasing healthcare worker efficiency, reducing costs associated with manual measurement of packaging storage history parameters and conditions, and reducing wasted material associated with improper environmental storage for medical products and related packaging.

In various embodiments, the system may include two kinds of indicators: a timer and a temperature sensor. While the timer senses and keeps track of time throughout the storage and preparation stages of a medical product, the temperature sensor senses and keeps track of the exposure temperature of the medical product, such as environmental temperature, throughout its storage and preparation stages.

More particularly, in the United States, certain medical products, such as Baxter Healthcare's TISSEEL fibrin sealant, are stored in a frozen state, in some instances for an extended period of time. In preparation for use, the TISSEEL fibrin sealant can be stored for up to 48 hours at room temperature after it has been thawed, and up to 12 hours at room temperature after it has been warmed. Once the medical product has been thawed or warmed, it should not be refrozen (e.g., the product should not be exposed to temperatures below 15 degrees Celsius) or overheated (e.g., the product should not be exposed to temperatures above 37 degrees Celsius). If any of the above conditions, such as individual time conditions or individual temperature conditions, are violated, the medical product must be discarded, as it can not be used in a medical procedure. Therefore, a time and temperature tracker will indicate, to either the original user or a later secondary user, whether the product has complied with all storage requirements during all stages of storage and preparation for use or, alternatively, if the product should be discarded.

Currently, hospital personnel are required to physically measure and record the time and temperature of the product anytime it undergoes a processing step resulting in a phase change (e.g., to frozen, to thawed, to warmed) and/or undergoes a transportation step resulting in a location change (e.g., to storage, to operating room, back to storage).

Hospital personnel are required to continually verify compliance with timing parameters. When the medical product is ready to be used, hospital personnel must perform a mental calculation to determine the total number of hours that have passed since certain events, such as the total time passed since product was removed from freezer, to ensure that the product has not expired. This mental calculation must be performed several times throughout a medical procedure. For example, among other medical steps, calculations must be performed during preparation of the medical product, prior to removal from storage, prior to thawing, prior to warming, prior to use, prior to any subsequent use, prior to storage, and prior to removal from storage. To needlessly avoid waste and ensure safe handling of the product, hospital personnel have to continually ensure that the product is in compliance with proper timing storage protocol.

Likewise, hospital personnel are required to continually verify compliance with temperature parameters. For example, when the medical product is ready to be used, hospital personnel must verify that the product has been kept at an appropriate temperature. Moreover, the appropriate temperature varies based upon which stage of preparation is being monitored. For example, appropriate temperature may differ for storage, thawing, warming, and use. Hospital personnel have to continually ensure that the product is in compliance with proper temperature storage protocol. Additionally, it is difficult if not impossible to ensure that the product has not been exposed to temperatures beyond the recommended limits. For example, while hospital personnel may measure temperature periodically at all stages (e.g., measured during storage, measured during thawing, and measured during warming) there may be a brief point in time where the temperature fluctuates beyond an acceptable range, known as a temperature excursion. This temperature excursion may be missed by periodic measurement. Even the slightest temperature excursion may affect the medical product to the point where it should no longer be used, but rather be discarded.

Thus, in time-sensitive medical environments, like surgical environments, it may be difficult, if not impossible, for hospital personnel to determine if a medical product has complied with all storage requirements. This is crucial when medical products are being used in high-risk procedures such as surgical procedures for bleeding control and hemostasis. Therefore, a reliable and accurate time and temperature tracking and detection device will ensure that medical products used in procedures are in compliance with all storage requirements. The device will also assist hospital personnel in making efficient and accurate decisions in preparing and using medical devices, which also reduces the costs associated with wasted time, by eliminating the need for mental calculations, and wasted material, by ensuring that medical product is optimized.

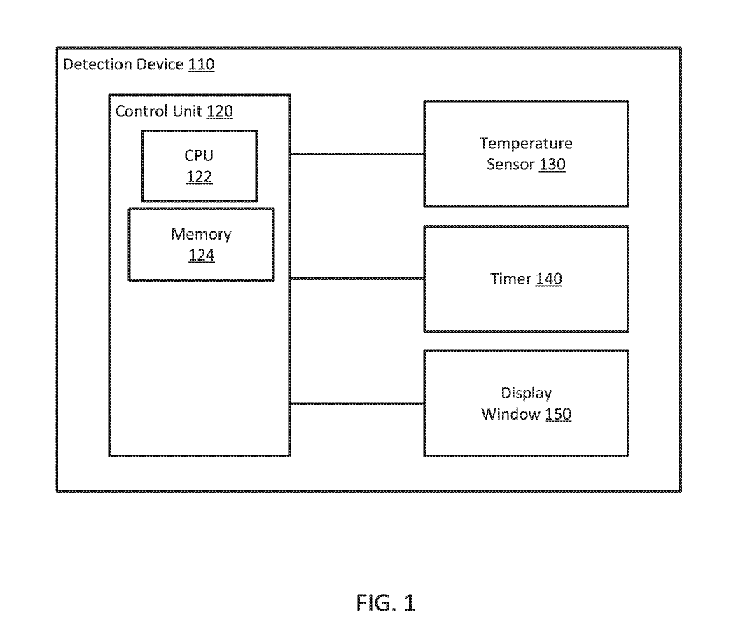

FIG. 1 illustrates a schematic view of a detection device 110 in accordance with an example embodiment of the present disclosure. Detection device 110 includes a control unit 120, which includes processor 122 and memory 124.

In various embodiments, control unit 120 communicates with a temperature sensor 130, which is configured to detect a temperature of a material, such as a medical product, that is in contact (e.g., physical contact or physical proximity) with temperature sensor 130. In a different embodiment, temperature sensor 130 is configured to detect an environmental temperature, like an environmental storage temperature. In an embodiment, temperature sensor 130 includes one or more sensors, such as a negative temperature coefficient (NTC) thermistor, a resistance temperature detector (RTD), a thermocouple, a semiconductor-based sensor, or any other type of sensor configured for detecting a temperature. In a typical embodiment, temperature sensor 130 has a range of 0 degrees Celsius to 100 degrees Celsius, though it should be appreciated that temperature sensor 130 may be capable of larger or smaller ranges.

In various embodiments, control unit 120 communicates with a timer 140, which includes one or more timers and is configured to determine a time (e.g., a storage time, expiration time, or some other time). In one example embodiment, timer 140 may be a stopwatch timer (e.g., counting up from zero), a countdown timer (e.g., counting down from a specified time interval to an expiry), a mechanical timer (e.g., a spring based timer), an electromechanical timer (e.g., a short-period bimetallic timer, electromechanical cam timer, electromechanical controller, or some other electromechanical timer), or an electronic timer (e.g., quartz clock, single-chip computer system, programmable logic controller, o some other electronic timer). In a typical embodiment, timer 140 has a range of 48 hours, though it should be appreciated that timer 140 may be capable of larger or smaller ranges.

In various embodiments, control unit 120 communicates with a display window 150, which is configured to display one or more messages, such as label(s). In an embodiment, display window 150 may be a cathode ray tube display (CRT), light-emitting diode display (LED), electroluminescent display (ELI)), electronic paper, e-ink, display, plasma display panel (PDP), liquid crystal display (LCD), or an organic light-emitting diode display (( )ID). In an embodiment, the message displayed via display window 150 is a text message (e.g., alpha-numeric text), a number, picture, symbol, color, or some combination thereof

Control unit 120 may he coupled to other processors, other memory devices, and other input/output devices (e.g., a network device, a network interface controller (NIC), a network adapter, any other component that connects a computer to a computer network, a peripheral component interconnect (PCI) device, storage devices, sound or video adaptors, photo/video cameras, printer devices, keyboards, or a displays).

In various embodiments, each of the components noted above, including control unit 120, temperature sensor 130, tinier 140, and display window 150, may be either hard-wire connected to one another, or connected to each other via a network. For example, the network may be a public network (e.g., the Internet), a private network (e.g., a local area network (LAN) or wide area network (WAN)), or a combination thereof.

As used herein, a physical processor or processor refers to a device capable of executing instructions encoding arithmetic, logical, and/or I/O operations. In an illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module, such as one in which individual microprocessor dies are included in a single integrated circuit package and hence share a single socket. A processor may also be referred to as a central processing unit (CPU).

As discussed herein, a memory device or memory refers to a volatile or non-volatile memory device, such as RAM, ROM, EEPROM, or any other device capable of storing data. Control unit 120 can further include a computer readable medium storing instructions, which, when executed cause detection device 110 to operate in the ways described herein.

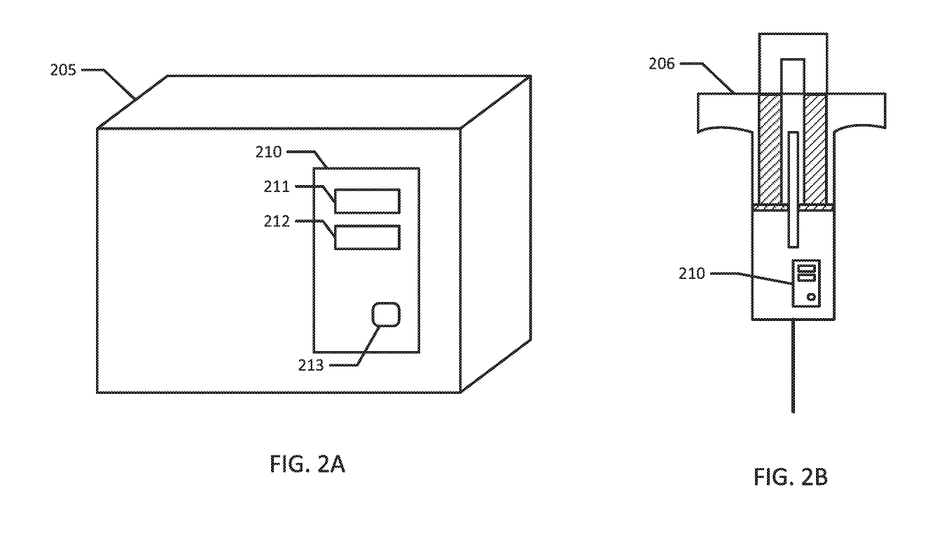

FIGS. 2A and 2B illustrate side elevation views of the detection device in accordance with example embodiments of the present disclosure. Referring now to FIG. 2A, a storage container 205 may be configured for storage and/or transportation of a medical product. For example, storage container 205 may be a box, package, or other container for storing and transporting medical products.

A detection device 210 may be affixed (either permanently or removably) to storage container 205. As discussed above, in various embodiments, detection device 210 may be configured for detecting times and temperatures (e.g., as detection device 110, discussed above) and for displaying messages. For example, in one embodiment, detection device 210 displays a first message (e.g., “Product Ready to be Used”) on a first label 211 and a second message (e.g., “Discard”) on a second label 212. In an embodiment, first label 211 and second label 212 are different labels on detection device 210 (e.g., the first message and second message may be displayed at different locations on detection device 210). In a different embodiment, first label 211 and second label 212 are included as one single label on detection device 210 (e.g., the first message and the second message may be displayed at the same location on detection device 210).

In various embodiments, detection device 210 may also include an activator 213 configured to activate detection device 210. For example, prior to activation, detection device 210 is in an off-mode, sleep-mode, or standby-mode, such that it may not display messages on labels. In an example, prior to activation, components related to detection device 210, such as control units, temperature sensors, timers, and display windows, are, likewise, in an off-mode, sleep-mode, or standby-mode. Responsive to activation via activator 213, detection device 210 may perform functions as described herein, including displaying messages on labels, measuring temperature, and measuring time, among other functions. In an embodiment, activator 213 is a push-button type switch. In other embodiments, activator 213 may be an electromechanical sensor, electrical sensor (e.g., RFID or Bluetooth, among other electrical sensors), or any other type of signal based sensor.

Detection device 210 may be affixed to other objects besides storage container 205. Referring now to FIG. 2B, detection device 210 is affixed to a syringe 206, which may be configured for delivering a medical product, such as Baxter Healthcare's TISSEEL fibrin sealant, during a medical procedure. In this configuration, it should be noted that components of detection device 210, such as the labels, are still visible to the user (e.g., doctors, nurses, and other medical personnel).

More particularly, in an embodiment, detection device 110 (or detection device 210) displays first label 211 in display window 150. Detection device 110 then detects, via temperature sensor 130, a first temperature, and determines a first temperature excursion. The first temperature excursion is an instance where the first temperature exceeds a first threshold. For example, thresholds may be defined by a specific medical product's Instruction for Use or Summary of Product Characteristics. Responsive to determining the first temperature excursion, detection device 110 starts timer 140. Timer 140 is configured to expire after the passing of a first duration of time. Detection device 110 then detects, via temperature sensor 130, a second temperature. When the second temperature exceeds a second threshold stored in memory, a second temperature excursion has occurred. Responsive to either: (i) timer 140 expiring after the first duration of time; or (ii) determining the second temperature excursion, detection device 110 displays second label 212 in display window 150.

In a related embodiment, responsive to displaying second label 212, detection device 110 restarts timer 140, where timer 140 is configured to expire after the passing of a second duration of time. Detection device 110 detects, via temperature sensor 130, a third temperature. Responsive to either: (i) tinier 140 expiring after the second duration of time; or (ii) determining a third temperature excursion, detection device 110 displays a third label in display window 150. The third temperature excursion in this embodiment is an instance where the third temperature exceeds a third threshold.

In another related embodiment, detection device 110 detects a fourth temperature via the temperature sensor 130, determines a fourth temperature excursion, and displays a fourth label in display window 150. Similar to the first, second, and third temperature excursions discussed above, the fourth temperature excursion is an instance where the fourth temperature exceeds a fourth threshold.

In another related embodiment, the fourth label is permanent such that, once display window 150 displays the fourth label, no other label may be subsequently displayed via the display window 150.

In another related embodiment, each of first label 211, second label 212, the third label, and the fourth label has a symbol, indicia, or alpha-numeric text that may include one or more of: (i) Ready to Be Thawed, (ii) Ready to Be Warmed, (iii) Ready to Be Used, and (iv) Discard. It should he appreciated that any suitable message or notification can be expressed through the various labels described herein.

In various embodiments, display window 150 has either individual or shared displays for each of first label 211 and second label 212. In another related embodiment, each of first label 211 and second label 212 are different colors. In an embodiment, each of the first temperature and the second temperature are environmental storage temperatures of storage container 205.

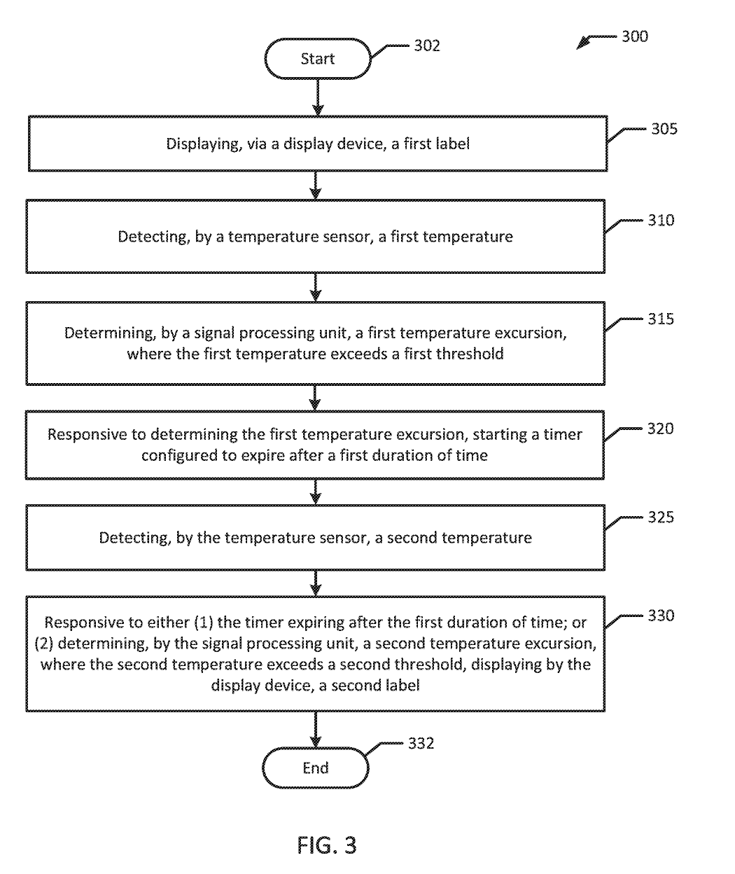

FIG. 3 illustrates a flow chart of an example method for displaying packaging storage history parameters and conditions in accordance with an example embodiment of the present disclosure. Although the example method 300 is described with reference to the flowchart illustrated in FIG. 3, it should be appreciated that many other methods of performing the acts associated with the method 300 may be used. For example, the order of some of the blocks may be changed, certain blocks may be combined with other blocks, and some of the blocks described are optional. The method 300 may be performed by processing logic that may include hardware, such as circuitry and dedicated logic, software, or a combination of both.

The example method 300 may start (block 302) with displaying, via a display device, such as display window 150, a first label 211 (block 305) and detecting, by temperature sensor 130, a first temperature (block 310).

Next, method 300 includes determining a first temperature excursion (block 315) using data from the temperature sensor 130. The first temperature excursion is an instance where the first temperature exceeds a first threshold stored in memory. Responsive to determining the first temperature excursion, example method 300 starts timer 140 (block 320), which is configured to expire after the passing of a first duration of time.

Next, example method 300 includes detecting a second temperature (block 325) via temperature sensor 130. When the second temperature exceeds a second threshold stored in memory, a second temperature excursion has occurred. Responsive to either (i) timer 140 expiring after the first duration of time, or (ii) determining the second temperature excursion, example method 300 includes displaying, via the display device, second label 212 (block 330). For example, second label 212 may be displayed via display window 150. Method 300 may end at this point (block 332).

In a related embodiment, method 300 may additionally include, responsive to displaying second label 212, restarting timer 140, where timer 140 is configured to expire after the passing of a second duration of time. Method 300 may additionally include detecting, by temperature sensor 130, a third temperature. When the third temperature exceeds a third threshold stored in memory, a third temperature excursion has occurred. Responsive to either: (i) timer 140 expiring after the second duration of time; or (ii) determining the third temperature excursion, method 300 may include displaying a third label in display window 150.

In another related embodiment, method 300 may include detecting a fourth temperature via temperature sensor 130. When the fourth temperature exceeds a fourth threshold stored in memory, a fourth temperature excursion has occurred. Method 300 may additionally include displaying a fourth label via display window 150.

In another related embodiment, the fourth label is permanently displayed in window 150 such that, once the display device displays the fourth label, no other label may be subsequently displayed via the display device. In other embodiments, other labels, like first label 211, second label 212, or the third label, may be permanent. For example, if any of the first label 211, the second label 212, the third label, or the fourth label indicate “Discard,” this could represent a point at which the medical product is no longer acceptable for use, for example, because the temperature of the medical product has reached a discard excursion temperature or because a timer has expired. In this example, it would be desirable to have the message “Discard” be permanently displayed, so that all subsequent users will see the label indicating “Discard” and will not inadvertently use the medical product at a later point in time.

In various embodiments, a user manually starts timer 140 (e.g., with a button or activator), which is configured to expire after the passing of the first duration of time. In various embodiments, a user can manually adjust a value associated with at least one of the first threshold and the second threshold. For example, the user may adjust the value of the first threshold depending on the type of medical product, due to the fact that different medical products may have different storage temperatures.

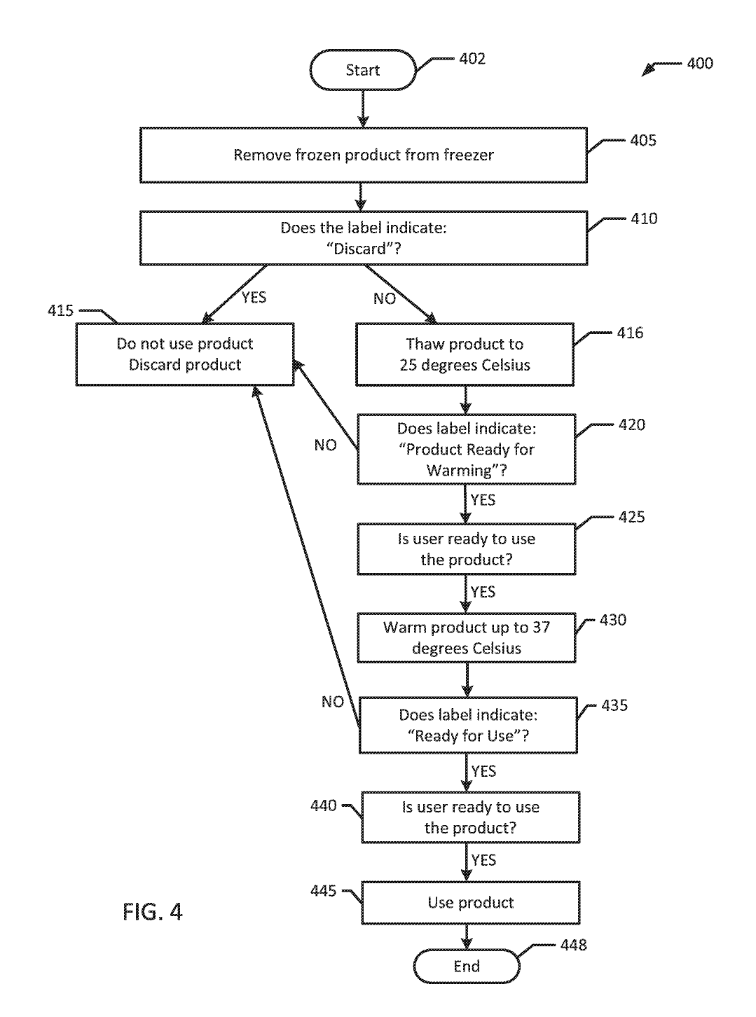

FIG. 4 illustrates a flow chart of an example method for a typical user workflow for storage and preparation of a frozen product in accordance with an example embodiment of the present disclosure. Although the example method 400 is described with reference to the flowchart illustrated in FIG. 4, it should be appreciated that many other methods of performing the acts associated with the method 400 may be used. For example, the order of some of the blocks may be changed, certain blocks may be combined with other blocks, and some of the blocks described are optional. The method 400 may be performed by processing logic that may include hardware, such as circuitry and dedicated logic, software, or a combination of both.

Method 400 may represent a typical user workflow for storage and preparation of the frozen product, including typical decisions that the user may he required to make. In one embodiment, method 400 begins (block 402) with removing the frozen product from a freezer (block 405). First, the user must check whether a label on the frozen product indicates “Discard” (block 410). If the label indicates “Discard,” the user should not use the product and it should be discarded (block 415). If the label does not indicate “Discard,” the user should thaw the product to 25 degrees Celsius (block 416). Once thawed, the user must check whether the label indicates “Product Ready for Warming” (block 420). If the label does not indicate “Product Ready for Warming,” but rather indicates a different message, such as “Discard,” the user should not use the product and it should be discarded (block 415). If the label does indicate “Product Ready for Warming,” the user should determine whether the user is ready to use the product (block 425).

In an example embodiment, one of two labels must be displayed (e.g., at block 420): “Product Ready for. Warming” or “Discard.” “Discard” could represent a point at which the medical product is no longer acceptable for use, for example, because the temperature of the medical product has reached a discard excursion temperature or because a timer has expired. In this example, it would be desirable to have the message “Discard” be permanently displayed, so that all subsequent users will see the label indicating “Discard” and will not inadvertently use the medical product at a later point in time.

If the user is ready to use the product, the user should warm the product up to 37 degrees Celsius (block 430). In an embodiment, specific warming temperatures may be dictated by individual product requirements. Once warmed, the user must check whether the label indicates “Ready for Use” (block 435). If the label does not indicate “Ready for Use,” the user should not use the product and it should be discarded (block 415). If the label does indicate “Ready for Use,” the user should determine whether the user is ready to use the product (block 440).

In an example embodiment, one of two labels must be displayed (e.g., at block 435): “Ready for Use” or “Discard.” “Discard” could represent a point at which the medical product is no longer acceptable for use, for example, because the temperature of the medical product has reached a discard excursion temperature or because a timer has expired. In this example, it would be desirable to have the message “Discard” be permanently displayed, so that all subsequent users will see the label indicating “Discard” and will not inadvertently use the medical product at a later point in time.

If the user is ready to use the product, the user should use the product (block 445). Method 400 may end at this point (block 448).

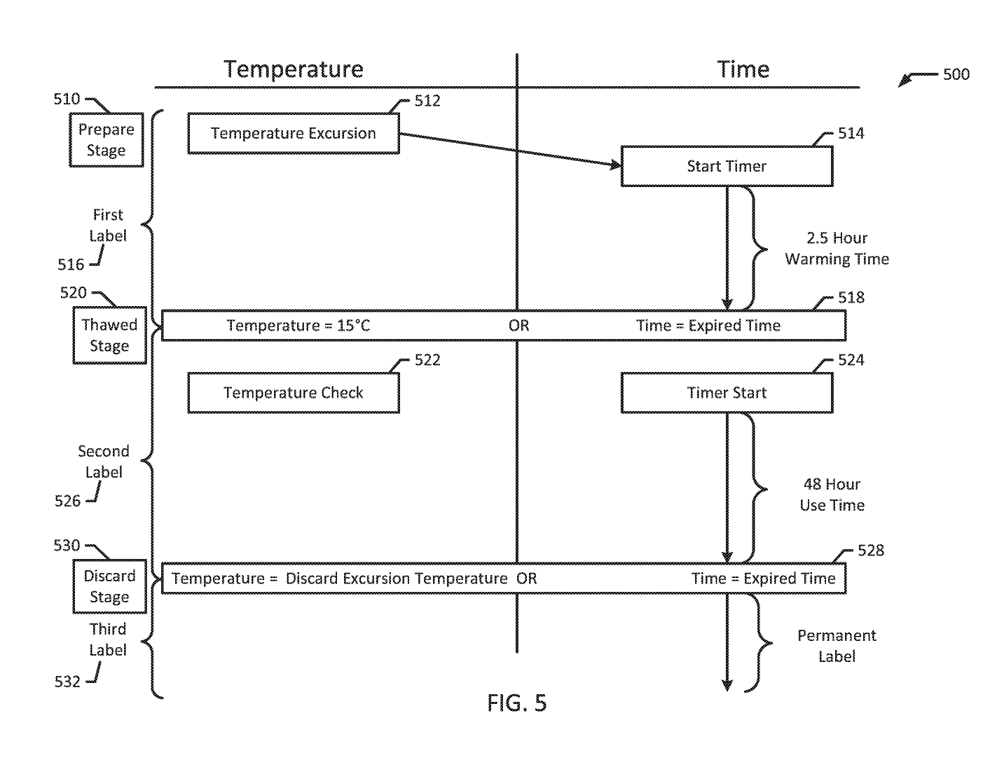

FIG. 5 illustrates a flow chart of an example method for using the detection device in accordance with an example embodiment of the present disclosure. Although the example method 500 is described with reference to the flowchart illustrated in FIG. 5, it will be appreciated that many other methods of performing the acts associated with the method 500 may be used. For example, the order of some of the blocks may be changed, certain blocks may be combined with other blocks, and some of the blocks described are optional. The method 500 may be performed by processing logic that may include hardware, such as circuitry and dedicated logic, software, or a combination of both.

Method 500 may include three distinct stages: prepare stage 510, thawed stage 520, and discard stage 530. In this example, each of the three distinct stages is associated with a particular step in preparing a medical product for use in a medical procedure. For example, prepare stage 510 may be associated with the steps of removing the medical product from storage, such as from a freezer, and warming the medical product to be used in the procedure. Likewise, for example, thawed stage 520 may be associated with the step of using the medical product during the medical procedure. Likewise, for example, discard stage 530 may be associated with the step of discarding the medical product, if it is no longer usable for the medical procedure. It should be noted that many other distinct stages are possible, beyond those described by this example.

Referring to FIG. 5, prepare stage 510 begins with a temperature excursion 512. In an embodiment, temperature excursion 512 may he a warm temperature experienced by the detection device, such as detection device 110, when packaging to which the detection device is affixed, such as storage container 205, is removed from a freezer. In various embodiments, temperature excursion 512 is caused by ambient room temperature air or other warming scenarios. For example, temperature excursion 512 may be a temperature detected by the detection device 110 when the packaging to which the detection device is affixed is placed in a warming bath. It should be appreciated that the specific temperature associated with temperature excursion 512 may be pre-determined (e.g., the temperature may be fixed and pre-loaded onto display the device) or adjustable (e.g., among other reasons, the temperature may be adjustable based on a particular medical product, or particular jurisdictional requirements for products in different countries). In an alternate embodiment, prepare stage 510 begins with an activation, such as via activator 213, instead of temperature excursion 512.

Once prepare stage 510 begins, method 500 may include starting a timer 514 either in response to temperature excursion 512 (e.g., once the ambient temperature is 15 degrees Celsius, upon removal from a storage freezer) or in response to an activation, such as via activator 213.

Once the timer 514 is started, there is an inherent warming period (e.g., a 2.5 hour warming time) while the medical product transitions from a frozen state to a viscous state. The action of warming may be performed in any appropriate manner, such as by exposure to ambient air temperature or warming bath. During the prepare stage 510 (e.g., during the 2.5 hour warming time), first label 516 may display a first message: “Ready to be Thawed” or “Ready to be Warmed.” The first message indicates to a user that the medical product is acceptable for preparation, and may be prepared accordingly. In an embodiment, first label 516 is displayed via the detection device 110 with a temperature activated dye. For example, first label 516 is displayed in response to temperature excursion 512 (e.g., triggering the display of first label 516 via the temperature activated dye). In various embodiments, first label 516 may be a text message, such as alpha-numeric text, a number, picture, symbol, color, or some combination thereof.

Next, method 500 includes a first determination 518, wherein the detection device determine that the temperature of the medical product is at an appropriate level (e.g., the medical product has transitioned from a frozen state to a viscous state, and is at 15 degrees Celsius). Alternatively, at step 518, the detection device determines that the timer 514 has expired (e.g., the 2.5 hour warming time has elapsed). In an embodiment, first determination 518 requires only one of the two measurements (appropriate temperature measurement or time expiration) to be satisfied. In an alternative embodiment, first determination 518 requires both of the two measurements above to be satisfied. In further embodiment, first determination 518 requires additional measurements, such as a viscosity measurement of the medical product, to be satisfied. Responsive to the first determination 518 being satisfied, method 500 may proceed to the thawed stage 520.

In various embodiments, once thawed stage 520 begins, method 500 starts a timer 524 in response to a temperature check 522 (e.g., a temperature excursion in which the medical product is 15 degrees Celsius, after warming is completed). In a different embodiment, starting the timer 524 occurs in response to an activation, such as via activator 213. In another different embodiment, starting the timer 524 occurs in response to timer 514 expiring. In an embodiment, the timer in prepare stage 510 is different than the timer in thawed stage 520. In a different embodiment, it is the same timer, such that the timer resets as method 500 transitions from prepare stage 510 to thawed stage 520.

Once the timer 524 is started, there is a use period (e.g., a time period with which to use the product), the length of which is dependent on the temperature of the medical product (e.g., as determined via temperature check 522). In an example, once the temperature of the medical product is 15 degrees Celsius, the product must be used within 48 hours, or else it must be discarded (e.g., when temperature check 522 measures 15 degrees Celsius, timer 524 is started with a 48 hour countdown). In another example, once the temperature of the medical product is 25 degrees Celsius, the product must be used within 12 hours, or else it must be discarded (e.g., when temperature check 522 measures 25 degrees Celsius, timer 524 is started with a 12 hour countdown).

In yet another example, timer 524 adjusts, based on the temperature measured by temperature check 522. For example, as described above, once the temperature of the medical product is 15 degrees Celsius, the product must he used within 48 hours, or else it must be discarded; likewise, once the temperature of the medical product is 25 degrees Celsius, the product must be used within 12 hours, or else it must be discarded. These two limits may be complementary to one another. For example, once the temperature of the medical product reaches 15 degrees Celsius, timer 524 is set to 48 hours and started. Once the temperature of the medical product reaches 25 degrees Celsius, timer 524 is reset to 12 hours, for example, because the product expires faster in warmer temperature. However, the product may be placed in temporary storage, such as a refrigerator. In this example, once the product is placed into storage, the temperature of the product may decrease, such as from 25 degrees Celsius to 15 degrees Celsius. If this happens, timer 524 will readjust, and reset back to 48 hours. In a related embodiment, readjustment will take into account previous times that the medical product has already spent in various temperatures. For example, a medical product may spend 6 hours at 15 degrees Celsius, and then spend 2 hours at 25 degrees Celsius; when the product is placed into temporary storage, and timer 524 is reset to 48 hours, timer 524 will account for the 6 hours already spent at 15 degrees Celsius. In other words, timer 524 will readjust to 42 hours (e.g., 48 hours less 6 hours is 42 hours). In another related embodiment, timer 524 will take into account other previous times (e.g., account for the 6 hours spent at 15 degrees Celsius and the 2 hours spent at 25 degrees Celsius, and readjust to 40 hours)

During the thawed stage 520 (e.g., once the product has reached a temperature in the range of 33 to 37 degrees Celsius and the product is still within the 48 hour use time), second label 526 may display a second message. For example, if a temperature check 522 determines that the product has reached the appropriate temperature, the second label 526 is triggered. In various embodiments, second label 526 displays “Ready to be Used.” This may indicate, to the user, that the medical product is acceptable for use and may be used in a medical procedure. In an embodiment, second label 526 is displayed via the detection device, such as detection device 110, with a temperature activated dye. For example, second label 526 is displayed in response to temperature check 522 (e.g., triggering the display of second label 526 via temperature check 522). In various embodiments, second label 526 may be a text message, a number, picture, symbol, color, or some combination thereof.

In various embodiments, method 500 includes a second determination 528. For example, the detection device determines that either the timer 524 has expired, or that the temperature of the medical product has reached a discard excursion temperature (e.g., the medical product has reached a temperature threshold where it is no longer usable and must be discarded immediately). In an embodiment, second determination 528 requires only one of the two measurements described above to be satisfied. In an alternative embodiment, second determination 528 requires both of the two measurements above to be satisfied. In another different embodiment, second determination 528 requires additional measurements, such as a viscosity measurement of the medical product, to be satisfied.

Responsive to the second determination 528 being satisfied, method 500 may proceed to the discard stage 530.

Discard stage 530 represents the point at which the medical product is no longer acceptable for use. In various embodiments, the medical product is no longer acceptable for use because the temperature of the medical product has reached the discard excursion temperature or because timer 524 has expired. During discard stage 530, third label 532 displays a third message. For example, in one embodiment, third label 532 displays “Discard,” which indicates that the medical product is no longer acceptable for use and should he discarded immediately. In an embodiment, third label 532 is displayed via the detection device, such as detection device 110, with a temperature activated dye. For example, third label 532 is displayed in response to detecting the discard excursion temperature (e.g., the medical product has reached a temperature threshold where it is no longer usable). In various embodiments, third label 532 is a text message, a number, picture, symbol, color, or some combination thereof.

In a related embodiment, third label 532 is a permanent label. For example, once third label 532 is displayed, no other labels, like first label 516 and second label 526, may be subsequently displayed. In a related embodiment, measurements that result in the display of third label 532 may supersede all other events described above. For example, at any point in time during method 500, second determination 528 may be satisfied (e.g., at any point in time, the temperature of the medical product may reach the discard excursion temperature). Once second determination 528 is satisfied, method 500 immediately proceeds to the discard stage 530, because the medical product is no longer acceptable for use. It should he emphasized that third label 532 may be displayed at any time. For example, discard stage 530 may occur at any time during method 500 (e.g., before prepare stage 510, during prepare stage 510, before thawed stage 520, and during thawed stage 520). In this way, third label 532 and associated second determination 528 ensure continual compliance with particular temperature requirements. For example, this ensures that the medical product is within appropriate temperature limits or ranges at all times throughout its lifecycle (e.g., during frozen storage, during removal from frozen storage, during warming/thawing processes, during use processes, during temporary storage processes, during subsequent use processes, and during discard).

In an embodiment, as briefly mentioned above, detection device measures additional physical parameters of the medical product, such as a viscosity measurement of the medical product. For example, detection device 110 of one embodiment includes a viscometer to track the viscosity of the medical product. In an embodiment, detection device includes the viscometer in addition to other components, like temperature sensor and timer. The viscosity of particular medical products, such as Baxter Healthcare's TISSEEL fibrin sealant, typically changes as the temperature of the product changes (e.g., during the preparation of the product as it warms). Therefore a viscometer may provide additional information regarding the current stage (e.g., prepare stage 510, thawed stage 520, and discard stage 530) of the medical product. In various embodiments, viscosity measurements are used in tandem with other measurements, such as time and temperature measurements, to satisfy particular determinations and provide more comprehensive data related to the medical product's status and safety. In one embodiment, determination 518 requires either (i) a determination that the temperature of the medical product is at an appropriate level, or (ii) a determination that the tinier 514 has expired, or (iii) a determination that the viscosity of the medical product is at an appropriate level. Likewise, for example, viscosity measurements are capable of being used to determine the point at which the medical product is no longer acceptable, such as when method 500 has reached discard stage 530. In an embodiment, the medical product is no longer acceptable for use because the viscosity of the medical product has reached a viscosity excursion point, which may be a point of no return. As previously noted, during discard stage 530, third label 532 displays a third message, such as “Discard”.

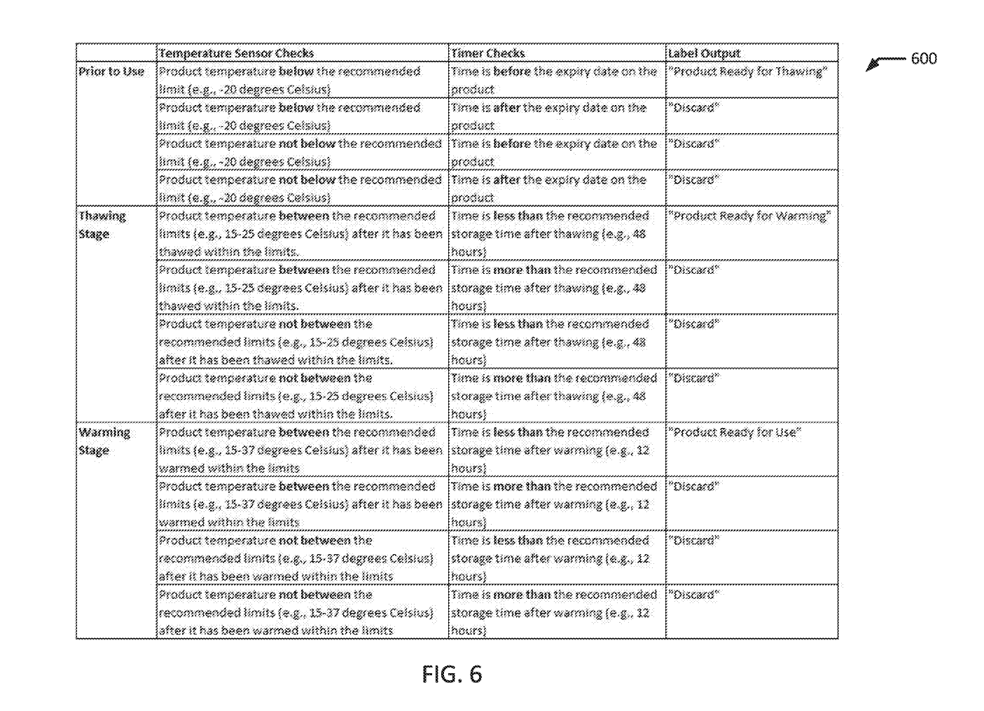

FIG. 6 is a table of exemplary times and temperatures for various preparation stages associated with the detection device according to an example embodiment of the present disclosure.

In an example embodiment, as illustrated by table 600 in FIG. 6, three stages are associated with the storage and preparation of typical medical products: prior to use stage, thawing stage, and warming stage. The prior to use stage includes the time period from storing the medical product in the freezer, up until the point when it is removed for subsequent use, the thawing stage includes the time period after the prior to use stage, including when the medical product is being thawed, and the warming stage includes the time period after the thawing stage, when the medical product is warmed, up until the product is either used during surgery or discarded.

As an example, during the prior to use stage, both a timer and a temperature sensor are activated while the product is stored, such as stored in a freezer. In an embodiment, the temperature sensor continually checks to see if the product has been exposed to temperatures beyond the recommended limits as defined in a user guide and the timer continually checks to see if the product is within the expiry date. If either of the timer and the temperature sensor that the product has been exposed to a particular event (e.g., among other events, a temperature excursion beyond the recommended limits or a time expiration of the product) a label output reads “Discard.” Alternatively, as long as the product has not been exposed to any of the particular events (e.g., the temperature excursion beyond the recommended limits and/or a time expiration of the product), the label output reads “Product Ready for Thawing.” In various embodiments, the temperature sensor and timer are disabled before removing the product from the freezer, for example, to avoid the label output reading “Discard” in response to a quick temperature change.

During the thawing stage of an embodiment, the product is removed from a freezer and a new label may be activated (e.g., activated for a second duration of time by hospital personnel). In this example, the label should be activated only when the product is about to be thawed. Once activated, the timer will keep track of the time that it takes to thaw the product (e.g., up to 48 hours). The timer also starts keeping track of the time that it takes to thaw as soon as the temperature of the product hits a threshold temperature (e.g., 15 degrees Celsius). Once a countdown timer expires (e.g., 48 hours), the label output is changed to read “Discard,” irrespective of the temperature sensor's current state. In an embodiment, during the thawing stage, the temperature sensor continually checks to see if the product has been exposed to temperatures outside of a given range (e.g., ensuring temperature is between 15 and 25 degrees Celsius). For example, various products must not be refrozen, and the temperature sensor ensures that such a refreezing event has not happened (e.g., ensuring temperature does not go below 15 degrees Celsius). Similarly, various products have upper temperature limits and must not overheated, and the temperature sensor ensures that such an overheating event has not happened (e.g., ensuring temperature does not go above 25 degrees Celsius). If either of these temperature conditions is violated, the label output may read “Discard.” In an example, once one of the temperature conditions is violated, the label output reads “Discard” irrespective of the timer's current state. If both of the timer and the temperature sensor are within recommended limits, as described above, the label output reads “Product Ready for Warming.”

In various embodiments, during the warming stage, the label is activated (e.g., activated for a third duration of time by hospital personnel). In this example, the label should be activated only when the product is about to be warmed. Once activated, the timer will start keeping track of the time that it takes to warm the product, up to 12 hours. The timer may also start keeping track of the time that it takes to warm as soon as the temperature of the product hits a threshold temperature (e.g., 25 degrees Celsius). The timer may start a countdown timer (e.g., 12 hours), and once the countdown timer expires, the label output may read “Discard.” In an example, once the countdown timer expires, the label output may read “Discard” irrespective of the temperature sensor's current state. During the warming stage, the temperature sensor may continually check to see if the product has been exposed to temperatures outside of a given range (e.g., ensuring temperature is between 33 and 37 degrees Celsius). If either of these temperature conditions is violated, the label output may read “Discard.” In an example, once one of the temperature conditions is violated, the label output may read “Discard.” In an example, once one of the temperature conditions is violated, the label output may read “Discard” irrespective of the timer's current state. If both of the timer and the temperature sensor are within recommended limits (e.g., temperature is between 33 and 37 degrees Celsius and timer has not expired), as described above, the label output may read “Product Ready for Use.”

In a related example embodiment, there are fewer or more stages. For example, a related embodiment may include a prior to use stage and a warming stage, but no thawing stage (e.g., combining thawing and warming into one stage).

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

1. A detection device comprising:
a signal processing unit in operable communication with:
a memory,
a temperature sensor,
a timer, and
a display window,
the detection device configured to:
display, via the display window, a first label;
detect, by the temperature sensor, a first temperature;
determine, by the signal processing unit, a first temperature excursion occurring when the first temperature exceeds a first threshold;
responsive to determining the first temperature excursion, start the timer configured to expire after a first duration of time,
detect, by the temperature sensor, a second temperature; and
responsive to either:
(1) the timer expiring after the first duration of time; or
(2) determining, by the signal processing unit, a second temperature excursion occurring when the second temperature exceeds a second threshold,
display, via the display window, a second label.

2. The detection device of claim 1, wherein the detection device is further configured to:
responsive to displaying the second label, restart the tinier configured to expire after a second duration of time;
detect, by the temperature sensor, a third temperature; and
responsive to either:
(i) the timer expiring after the second duration of time; or
(ii) determining, by the signal processing unit, a third temperature excursion occurring when the third temperature exceeds a third threshold,
display, via the display window, a third label.

3. The detection device of claim 1, wherein the detection device is further configured to:
detect, by the temperature sensor, a fourth temperature;
determine, by the signal processing unit, a fourth temperature excursion occurring when the fourth temperature exceeds a fourth threshold; and
display, via the display window, a fourth label.

4. The detection device of claim 3, wherein the fourth label is permanent such that, once the display window displays the fourth label, no other label may be subsequently displayed via the display window.

5. The detection device of claim 3, wherein each of the first label, the second label, the third label, and the fourth label has text that may include one or more of (i) Ready to Be Thawed; (ii) Ready to Be Warmed; (iii) Ready to Be Used; and (iv) Discard.

6. The detection device of claim 1, wherein the display window has individual displays for each of the first label and the second label.

7. The detection device of claim 1, wherein the display window has a shared display for both of the first label and the second label.

8. The detection device of claim 1, wherein each of the first label and the second label are different colors.

9. The detection device of claim 1, further comprising an activator, wherein a user manually starts the timer via the activator, and wherein the timer is configured to expire after the first duration of time.

10. The detection device of claim 1, herein a user manually adjusts a value associated with at least one of the first threshold and the second threshold.

11. A packaging system comprising:
a storage container; and
a detection device affixed to the storage container, wherein the detection device is configured to:
display a first label,
detect a first temperature,
determine a first temperature excursion occurring when the first temperature exceeds a first threshold,
responsive to determining the first temperature excursion, start a timer configured to expire after a first duration of time,
detect a second temperature, and
responsive to either:
(1) the timer expiring after the first duration of time; or
(2) determining a second temperature excursion occurring when the second temperature exceeds a second threshold,
display a second label.

12. The packaging system of claim 11, wherein the detection device is further configured to:
responsive to displaying the second label, restart the timer configured to expire after a second duration of time;
detect a third temperature; and
responsive to either:
(i) the timer expiring after the second duration of time; or
(ii) determining a third temperature excursion occurring when the third temperature exceeds a third threshold,
display a third label.

13. The packaging system of claim 12, wherein each of the first label, the second label, and the third label has text that may include one or more of: (i) Ready to Be Thawed; (ii) Ready to Be Warmed; (iii) Ready to Be Used; and (iv) Discard.

14. The packaging system of claim 11, wherein each of the first temperature and the second temperature are environmental storage temperatures of the storage container.

15. A method of displaying packaging parameters comprising:
displaying, via a display device, a first label;
detecting, by a temperature sensor, a first temperature;
determining, by a signal processing unit, a first temperature excursion occurring when the first temperature exceeds a first threshold;
responsive to determining the first temperature excursion, starting a timer configured to expire after a first duration of time;
detecting, by the temperature sensor, a second temperature; and
responsive to either:
(1) the timer expiring after the first duration of time; or
(2) determining, by the signal processing unit, a second temperature excursion, wherein the second temperature exceeds a second threshold,
displaying via the display device, a second label.

16. The method of claim 15, further comprising:
responsive to displaying the second label, restarting the timer configured to expire after a second duration of time;
detecting, by the temperature sensor, a third temperature; and
responsive to either:
(i) the timer expiring after the second duration of time; or
(ii) determining, by the signal processing unit, a third temperature excursion occurring when the third temperature excursion exceeds a third threshold,
displaying via the display device, a third label.

17. The method of claim 15, further comprising:
detecting, by the temperature sensor, a fourth temperature;
determining, by the signal processing unit, a fourth temperature excursion occurring when the fourth temperature exceeds a fourth threshold; and
displaying, via the display device, a fourth label.

18. The method of claim 17, wherein the fourth label is permanent such that, once the display device displays the fourth label, no other label may be subsequently displayed via the display device.

19. The method of claim 15, wherein a user manually starts the timer, via an activator, configured to expire after the first duration of time.

20. The method of claim 15, wherein a user manually adjusts a value associated with at least one of the first threshold and the second threshold.
